(19) United States
(12) Patent Application Publication
(10) Pub. No.: US 2024/0253526 A1
(43) Pub. Date: Aug. 1, 2024

(54) CHARGE AND DISCHARGE MANAGEMENT SYSTEM AND VEHICLE

(71) Applicant: TOYOTA JIDOSHA KABUSHIKI KAISHA, Toyota-shi (JP)

(72) Inventors: Hideo SAKAMOTO, Toyota-shi (JP); Hiroyouki OGURA, Ama-shi (JP); Hisashi FUJISAWA, Toyota-shi (JP); Shoichi IWAMOTO, Fuji-shi (JP); Mitsuaki TOMITA, Toyota-shi (JP); Yasunobu SEKI, Nisshin-shi (JP); Yoshinobu NOZAKI, Anjo-shi (JP)

(73) Assignee: TOYOTA JIDOSHA KABUSHIKI KAISHA, Toyota-shi (JP)

(21) Appl. No.: 18/502,988

(22) Filed: Nov. 6, 2023

(30) Foreign Application Priority Data
Jan. 30, 2023 (JP) 2023-011927

(51) Int. Cl. B60L 58/25; B60L 53/67

(52) U.S. Cl. CPC B60L 58/25; B60L 53/67

(57) ABSTRACT

A charge and discharge management system for managing charging/discharging of a power storage device in a plurality of vehicles having a power storage device and capable of performing external charging for charging the power storage device using electric power from an external power supply and external power supply for supplying power from the power storage device to the outside of the vehicle. A system obtains the scheduled departure times of a plurality of parked vehicles, and determines, among the plurality of vehicles, vehicles whose outside air temperature is lower than the lowest temperature in a predetermined temperature range. To terminate external charging or external power supply at a time closer to a scheduled departure time than a vehicle under environmental conditions.

### CROSS-REFERENCE TO RELATED APPLICATION

This application claims priority to Japanese Patent Application No. 2023- 011927 filed on Jan. 30, 2023 incorporated herein by reference in its entirety.

### BACKGROUND

### 1. Technical Field

The present disclosure relates to a charge and discharge management system and a vehicle.

### 2. Description of Related Art

Hitherto, as this type of charge and discharge management system, there has been proposed a system that manages the charging of a power storage device in a vehicle that includes a power storage device and is capable of external charging in which the power storage device is charged by using electric power from an external power supply (see, for example, Japanese Unexamined Patent Application Publication No. 2019-46737 (JP 2019-46737 A)). This system includes a heater that heats the power storage device, and the heater heats the power storage device to raise the temperature of the power storage device.

### SUMMARY

In the charge and discharge management system described above, the power storage device is heated by the heater. Therefore, the power storage rate of the power storage device decreases by the amount of electric power consumed by the heater. As a method for suppressing the decrease in the power storage rate, there is a method for supplementing the electric power consumed by the heater by the external charging. However, this method increases the power consumption when considering a power system including an external power source and a vehicle.

A main object of the charge and discharge management system and the vehicle of the present disclosure is to raise the temperature of a power storage device while suppressing an increase in power consumption.

The charge and discharge management system and the vehicle of the present disclosure take the following measures to achieve the above main object.

In summary, the charge and discharge management system of the present disclosure is configured to: manage charging and discharging of power storage devices of a plurality of vehicles including the power storage devices and configured to perform external charging for charging the power storage devices by using electric power from an external power source and to perform external power supply for supplying electric power from the power storage devices to outside of the vehicles; acquire a scheduled departure time of each of the vehicles being parked; and terminate the external charging or the external power supply at a time close to the scheduled departure time for the vehicle under an environment where an outside temperature is lower than a minimum temperature in a predetermined temperature range among the plurality of vehicles compared to the vehicle under an environment where the outside temperature is equal to or higher than the minimum temperature among the plurality of vehicles.

The charge and discharge management system of the present disclosure acquires the scheduled departure time of each of the vehicles being parked, and terminates the external charging or the external power supply at the time close to the scheduled departure time for the vehicle under the environment where the outside temperature is lower than the minimum temperature in the predetermined temperature range among the plurality of vehicles compared to the vehicle under the environment where the outside temperature is equal to or higher than the minimum temperature among the plurality of vehicles. When the external charging or the external power supply is performed while the vehicle is parked, the temperature of the power storage device rises by charging or discharging. Therefore, the external charging or the external power supply is terminated at the time close to the scheduled departure time for the vehicle under the environment where the outside temperature is lower than the minimum temperature in the predetermined temperature range among the plurality of vehicles compared to the vehicle under the environment where the outside temperature is higher than the minimum temperature among the plurality of vehicles. Thus, the temperature of the power storage device can be raised at the scheduled departure time. Since the power storage device is charged or discharged by the external charging or the external power supply of the power storage device, the increase in the power consumption can be suppressed compared to a case where the temperature of the power storage device is raised by a heating device such as a heater. As a result, it is possible to raise the temperature of the power storage device while suppressing the increase in the power consumption. The “predetermined temperature range” may include a range predetermined as a temperature range in which deterioration of the power storage device is slow.

The charge and discharge management system of the present disclosure may be configured to terminate the external charging or the external power supply at a time far from the scheduled departure time for the vehicle under an environment where the outside temperature is higher than a maximum temperature in the predetermined temperature range among the plurality of vehicles compared to the vehicle under an environment where the outside temperature is within the predetermined temperature range among the plurality of vehicles. In the vehicle under the environment where the outside temperature is higher than the maximum temperature among the plurality of vehicles, the temperature of the power storage device is likely to rise by the external charging or the external power supply. Therefore, the external charging or the external power supply is terminated at the time far from the scheduled departure time for such a vehicle. Thus, it is possible to reduce the occurrence of a case where the temperature of the power storage device rises at the scheduled departure time.

In summary, the vehicle of the present disclosure includes a power storage device. The vehicle is configured to: perform external charging for charging the power storage device by using electric power from an external power source and perform external power supply for supplying electric power from the power storage device to outside of the vehicle; acquire a scheduled departure time; and terminate the external charging or the external power supply at a time close to the scheduled departure time in a case where an outside temperature is lower than a minimum temperature in a predetermined temperature range compared to a case where the outside temperature is equal to or higher than the minimum temperature.

The vehicle of the present disclosure acquires the scheduled departure time, and terminates the external charging or the external power supply at the time close to the scheduled departure time in the case where the outside temperature is lower than the minimum temperature in the predetermined temperature range compared to the case where the outside temperature is equal to or higher than the minimum temperature. When the external charging or the external power supply is performed while the vehicle is parked, the temperature of the power storage device rises by charging or discharging. Therefore, the external charging or the external power supply is terminated at the time close to the scheduled departure time in the case where the outside temperature is lower than the minimum temperature in the predetermined temperature range compared to the case where the outside temperature is equal to or higher than the minimum temperature. Thus, the temperature of the power storage device can be raised at the scheduled departure time. Since the power storage device is charged or discharged by the external charging or the external power supply at this time, the increase in the power consumption can be suppressed compared to a case where the temperature of the power storage device is raised by a heating device such as a heater. As a result, it is possible to raise the temperature of the power storage device while suppressing the increase in the power consumption. The “predetermined temperature range” may include a range predetermined as a temperature range in which deterioration of the power storage device is slow.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a configuration diagram showing an outline of the configuration of an electric power system 10 incorporating a charge and discharge management system as one embodiment of the present disclosure;

FIG. 2 is a configuration diagram showing an outline of the configuration of the battery electric vehicle 20; and

FIG. 3 is a flowchart showing an example of a processing routine executed by the CPU of the management device 92.

### DETAILED DESCRIPTION OF EMBODIMENTS

Next, a mode for carrying out the present disclosure will be described with reference to an embodiment.

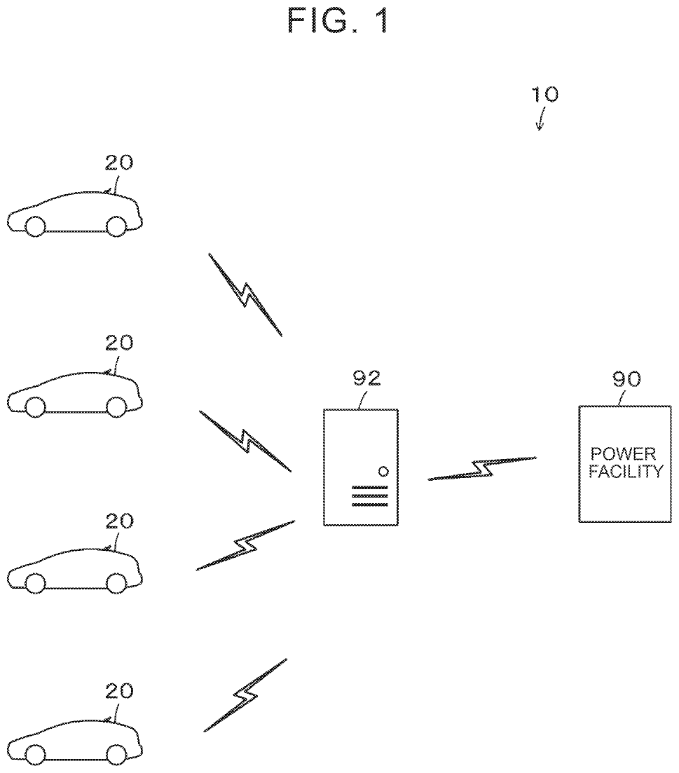

FIG. 1 is a configuration diagram showing an outline of the configuration of an electric power system 10 incorporating a charge and discharge management system as one embodiment of the present disclosure. The electric power system 10 is configured as a virtual power plant that generates power for transmission to power grids that supply power to individual homes and factories. The electric power system 10 includes a plurality of battery electric vehicle 20, a power facility 90, and a management device 92.

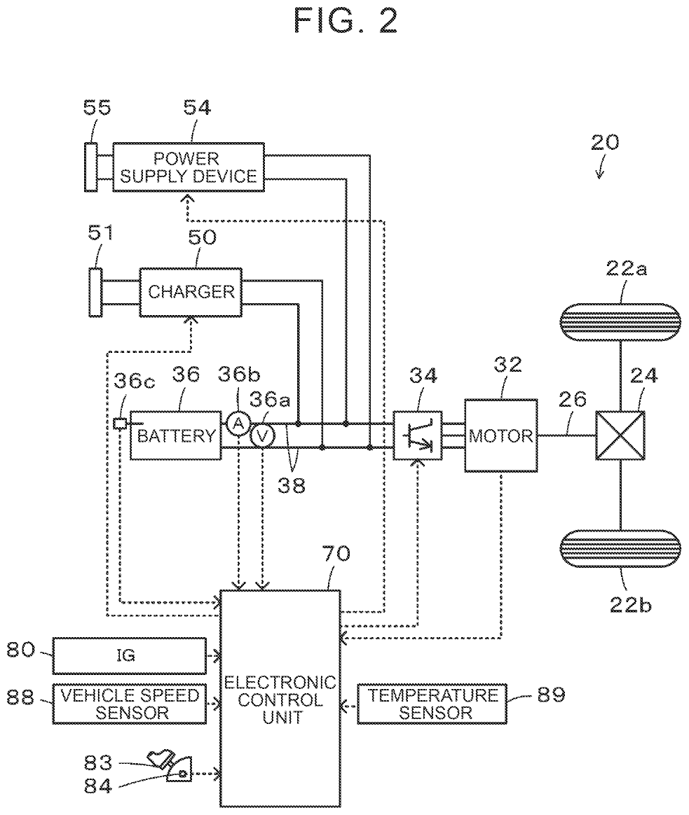

FIG. 2 is a configuration diagram showing an outline of the configuration of the battery electric vehicle 20. Each battery electric vehicle 20 is configured to act as an energy resource in a virtual power plant. Each battery electric vehicle 20 includes a motor 32, an inverter 34, a battery 36 as a power storage device, a charger 50, a power supply device 54, and an electronic control unit 70, as shown.

The motor 32 is connected to a drive shaft 26 whose rotors are connected to the drive wheels 22a and 22b via a differential gear 24. The inverter 34 is used to drive the motor 32 and is connected to the battery 36 via the power line 38. The motor 32 is rotationally driven by the switching control of a plurality of switching elements (not shown) of the inverter 34 by the electronic control unit 70. The battery 36 is configured as, for example, a lithium-ion secondary battery or a nickel-hydrogen secondary battery.

The charger 50 is connected to the power line 38 and uses power from the power grid when the power grid side connector connected to the power grid (external power source) and the vehicle side connector 51 are connected. It is configured to be able to perform external charging for charging the battery 36. This charger 50 is controlled by an electronic control unit 70.

The power supply device 54 is connected to the power line 38, and is configured to convert DC power of the power line 38 (battery 36) into AC power of a predetermined voltage (for example, 100 V) conforming to the power grid, and to be able to supply the converted power to the power grid when the power receiving side connector connected to the power grid and the power supply connector 55 are connected. The number of power supply connectors 55 is not limited to one, and may be two or more.

The electronic control unit 70 is configured as a microprocessor centered on a CPU (not shown), and in addition to the CPU, includes a ROM for storing processing programs, a RAM for temporarily storing data, an input/output port, and a communication port. Signals from various sensors are input to the electronic control unit 70 through input ports. Signals input to the electronic control unit 70 include, for example, the rotational position θm of the rotor of the motor 32 from a rotational position sensor (not shown) that detects the rotational position of the rotor of the motor 32, and the phase of each phase of the motor 32, and phase currents Iu, Iv, and Iw of each phase of the motor 32 from a current sensor (not shown) that detects the current. Further, the signals also include the voltage Vb of the battery 36 from the voltage sensor 36a attached between the terminals of the battery 36, the input/output current Ib of the battery 36 from the current sensor 36b attached to the output terminal of the battery 36, and the temperature Tb of the battery 36 from the temperature sensor 36c attached to the battery 36. The signals also include the ignition signal from the ignition switch 80, the accelerator operation amount Acc from the accelerator pedal position sensor 84 that detects the depression amount of the accelerator pedal 83, the vehicle speed V from the vehicle speed sensor 88, and the outside temperature from the temperature sensor 89 that detects the outside temperature Ta. Various control signals are output from the electronic control unit 70 through the output port. Examples of signals output from the electronic control unit 70 include a control signal to the inverter 34, a control signal to the charger 50, and a control signal to the power supply device 54. The electronic control unit 70 calculates the charge amount Sb of the battery 36 and the state of charge SOC based on the integrated value of the input/output current Ib of the battery 36 from the current sensor 36b. Here, the charge amount Sb is the amount of electric power that can be discharged from the battery 36, and the state of charge SOC is the ratio of the charge amount Sb (remaining amount) to the total capacity Scap of the battery 36. The electronic control unit 70 is configured to be able to communicate wirelessly with the management device 92.

In the battery electric vehicle 20 configured in this manner, the electronic control unit 70 sets the required torque Td* to the torque command Tm*, and operates the plurality of switching elements of the inverter 34 so that the motor 32 is driven by the torque command Tm*. Performs switching control.

Further, in the battery electric vehicle 20, when the vehicle side connector 51 and the power grid side connector are connected while the vehicle is parked, the electronic control unit 70 charges the battery 36 using power from the power grid. External charging is performed by controlling device 50. Then, when the state of charge SOC of battery 36 reaches a predetermined rate Smax, execution of external charging is terminated by terminating control of charger 50. As the predetermined ratio Smax, for example, 90%, 95%, 100%, etc. are used.

Furthermore, in the battery electric vehicle 20, when the power supply connector 55 is connected to the power receiving side connector connected to the power grid while the vehicle is parked, the electronic control unit 70 receives power from the battery 36 via the power line 38. External power feeding is performed by controlling the power supply device 54 to feed power to the power grid.

In the battery electric vehicle 20, the scheduled departure time td is set by the user's input when the vehicle is parked. As the scheduled departure time td, instead of input from the user, the electronic control unit 70 may learn in advance the parking location and the departure time at the parking location, store the departure time as the learning value of the departure time, and set the learning value of the departure time at the parking location to the scheduled departure time td.

Power facility 90 is configured to act as an energy resource in a virtual power plant. The power facility 90 is a facility capable of generating and storing electricity, and examples thereof include a solar power generation facility, a biomass power generation facility, and a large-scale power storage facility equipped with a large number of storage batteries. The power facility 90 is managed by a management device 92.

The management device 92 is configured to function as a resource aggregator and aggregation coordinator in the virtual power plant. The management device 92 is configured as a general-purpose microcomputer centering on a CPU. The management device 92 is configured to be able to communicate wirelessly with a plurality of battery electric vehicles 20 and power facilities 90.

In the electric power system 10 in which the charge and discharge management system of the embodiment configured as described above is incorporated, based on power supply and demand information from an installed supply and demand adjustment device such as a power transmission and distribution company (not shown) responsible for supply and demand adjustment with respect to the power grid, the management device 92 assigns a charge amount by external charging and a power supply amount by external power supply for each battery electric vehicle 20, also assigns the amount of power generation and the storage amount to the power facility 90, and performs a demand response (DR) that controls each battery electric vehicle 20 and the power facility 90 so that the assigned amounts are achieved. For example, when the demand for electric power to the power grid increases sharply, lowering DR is executed in which the parked battery electric vehicle 20 among the plurality of battery electric vehicles 20 is caused to perform external power supply and the amount of power generated in the power facility 90 is increased to suppress power shortage. Further, when surplus power is generated by the power facility 90 for the power grid, rising DR is executed in which the parked battery electric vehicle 20 among the plurality of battery electric vehicles 20 is caused to perform external charging or the power storage device of the power facility 90 is charged to suppress electric power from becoming excessive.

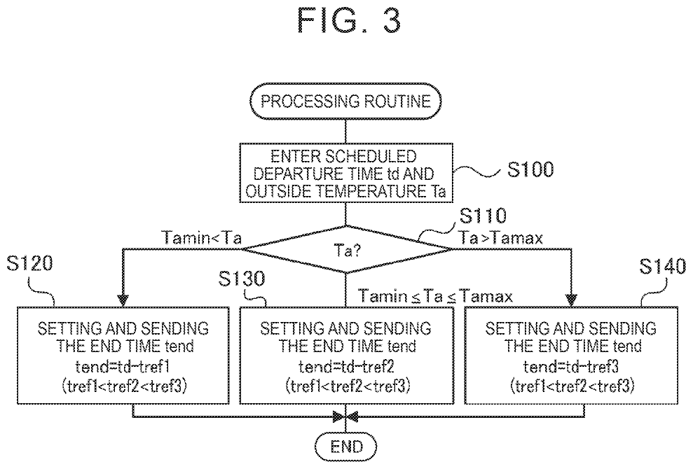

Next, the operation of the electric power system 10 in which the charge and discharge management system of the embodiment configured as described above is incorporated, in particular, the operation of raising the temperature of the batteries 36 mounted on the plurality of battery electric vehicles 20 will be described. FIG. 3 is a flowchart showing an example of a processing routine executed by the CPU of the management device 92. This routine is executed when a plurality of parked battery electric vehicles 20 are externally charged.

When this routine is executed, the CPU of the management device 92 executes a process of inputting the scheduled departure time td and the outside temperature Ta (S100). The scheduled departure time td is set by the battery electric vehicle 20 and input via communication. The outside temperature Ta detected by the temperature sensor 89 of the battery electric vehicle 20 is input via communication.

Subsequently, the input outside temperature Ta is checked (S110). When the input outside temperature Ta is lower than the lowest temperature Tamin, the external charging end time tend is set so that the external charging will end a predetermined time tref1 before the scheduled departure time td (S120). When the input outside temperature Ta is equal to or higher than the minimum temperature Tamin and equal to or lower than the maximum temperature Tamax (predetermined temperature range), the end time tend of external charging is set so that the external charging is completed a predetermined time tref2 before the scheduled departure time td (S130). When the input outside temperature Ta is higher than the maximum temperature Tamax, the end time tend of external charging is set so that the external charging will end a predetermined time tref3 before the scheduled departure time td (S130). Then, the routine ends. Here, the minimum temperature Tamin and the maximum temperature Tamax are temperatures set in advance by experiments, analyses, machine learning, etc. as the minimum temperature and the maximum temperature within the temperature range (predetermined range) in which the deterioration of the battery 36 is moderate. The predetermined times tref1, tref2, and tref3 are set to become shorter in this order. Therefore, the end time tend is set to be earlier in the following order: when the outside temperature Ta is lower than the minimum temperature Tamin, when the outside temperature Ta is between the minimum temperature Tamin and the maximum temperature Tamax, and when the outside temperature Ta is higher than the maximum temperature Tamax. The predetermined time tref1 is set to a relatively short time (e.g., 3 minutes, 5 minutes, 7 minutes, etc.). The electronic control unit 70 of the battery electric vehicle 20 that has received the end time tend sets the external charging start time tst based on the state of charge SOC of the battery 36 so that the external charging will end at the end time tend, and the set start time tst is set. External charging is started at time tst.

By such processing, among the plurality of battery electric vehicles 20, the battery electric vehicles 20 whose outside temperature Ta is lower than the minimum temperature Tamin are more likely to depart than the battery electric vehicles 20 whose outside temperature Ta exceeds the minimum temperature Tamin. External charging ends at a time close to the scheduled departure time td. When external charging is performed while the battery electric vehicle 20 is parked, the temperature of the battery 36 rises due to charging and discharging. Therefore, among the plurality of battery electric vehicles 20, the battery electric vehicle 20 under the environment where the outside temperature Ta is lower than the minimum temperature Tamin has a lower scheduled departure time than the vehicle under the environment where the outside temperature Ta is higher than the minimum temperature Tamin. By ending the external charging at a time close to td, the temperature of the battery 36 can be raised by the scheduled departure time td. Since the battery 36 is charged and discharged by external charging, it is possible to suppress an increase in power consumption compared to a heating device such as a heater that raises the temperature of the power storage device. As a result, the temperature of the battery 36 can be increased while suppressing an increase in power consumption.

Further, among the plurality of battery electric vehicles 20, the battery 36 of the battery electric vehicle 20 under the environment where the outside temperature Ta is higher than the maximum temperature Tamax tends to reach a high temperature due to external charging. Therefore, for the battery electric vehicle 20 whose outside temperature Ta exceeds the maximum temperature Tamax, at a time farther from the scheduled departure time td than for the battery electric vehicle 20 whose outside temperature Ta is equal to or higher than the minimum temperature Tamin and equal to or lower than the maximum temperature Tamax. By ending the external charging, it is possible to prevent the temperature of the battery 36 from reaching a high temperature at the scheduled departure time td.

In addition, although the operation at the time of performing external charge with respect to the several parked battery electric vehicles 20 in the rising DR was demonstrated in the Example, the same can be applied when the external charge is carried out with respect to several parked battery electric vehicles 20 in the lowering DR.

According to the electric power system 10 in which the charge and discharge management system of the embodiment described above is incorporated, among the plurality of battery electric vehicles 20, the battery electric vehicle 20 whose outside temperature Ta is lower than the minimum temperature Tamin has an outside temperature Ta. By completing the external charging at a time closer to the scheduled departure time td than the battery electric vehicle 20 exceeding the minimum temperature Tamin, the temperature of the battery 36 can be raised while suppressing an increase in power consumption.

Further, among the plurality of battery electric vehicles 20, the battery electric vehicle 20 under the environment where the outside temperature Ta is higher than the maximum temperature Tamax has an outside temperature Ta at the minimum temperature Tamin or more and the maximum temperature Tamax or less at the scheduled departure time td. By ending the external charging at a later time, the temperature of the battery 36 can be raised while suppressing an increase in power consumption.

In the electric power system 10 incorporating the charge and discharge management system of the embodiment, from S110 to S140, when the outside temperature Ta is lower than the minimum temperature Tamin, when the outside temperature Ta is between the minimum temperature Tamin and the maximum temperature Tamax, The end time tend is changed depending on whether the temperature Ta is the maximum temperature Tamax. However, the end time tend may be changed depending on whether the outside temperature Ta is lower than the minimum temperature Tamin or when the outside temperature Ta is equal to or higher than the minimum temperature Tamin. In this case, the battery electric vehicle 20 whose outside temperature Ta is lower than the minimum temperature Tamin has an end time tend closer to the scheduled departure time td than the battery electric vehicle 20 whose outside temperature Ta is equal to or higher than the minimum temperature Tamin.

In the electric power system 10 incorporating the charge and discharge management system of the embodiment, the management device 92 executes the processing routine illustrated in FIG. 3. However, electronic control unit 70 of battery electric vehicle 20 may perform the processing routine illustrated in FIG. 3. In this case, S100 is a process of inputting the vehicle's scheduled departure time td and the outside temperature Ta. When the external temperature Ta of the vehicle is lower than the minimum temperature Tamin, in each of the battery electric vehicles 20, the end time tend may be set so that the external charging ends at a time closer to the scheduled departure time td compared to a case where the external temperature Ta is equal to or higher than the minimum temperature Tamin.

The correspondence between the main elements of the embodiment and the main elements of the present disclosure described in SUMMARY will be described. In the embodiment, the management device 92 corresponds to a “charge and discharge management system”. Also, the battery electric vehicle 20 corresponds to the “vehicle”.

As for the correspondence between the main elements of the embodiment and the main elements of the present disclosure described in SUMMARY, since the embodiment is an example for specifically describing a mode for carrying out the present disclosure described in SUMMARY, the embodiment does not limit the elements of the present disclosure described in SUMMARY. In other words, the interpretation of the present disclosure described in SUMMARY should be performed based on the description in SUMMARY, and the embodiment is merely a specific example of the present disclosure described in SUMMARY.

Although a mode for carrying out the present disclosure has been described above with reference to the embodiment, the present disclosure is not limited to the embodiment, and it goes without saying that the present disclosure can be carried out in various modes without departing from the gist of the present disclosure.

The present disclosure is applicable to charge and discharge management systems, vehicle manufacturing industries, and the like.

What is claimed is:

1. A charge and discharge management system configured to:
manage charging and discharging of power storage devices of a plurality of vehicles including the power storage devices and configured to perform external charging for charging the power storage devices by using electric power from an external power source and to perform external power supply for supplying electric power from the power storage devices to outside of the vehicles;
acquire a scheduled departure time of each of the vehicles being parked; and
terminate the external charging or the external power supply at a time close to the scheduled departure time for the vehicle under an environment where an outside temperature is lower than a minimum temperature in a predetermined temperature range among the plurality of vehicles compared to the vehicle under an environment where the outside temperature is equal to or higher than the minimum temperature among the plurality of vehicles.

2. The charge and discharge management system according to claim 1, wherein the charge and discharge management system is configured to terminate the external charging or the external power supply at a time far from the scheduled departure time for the vehicle under an environment where the outside temperature is higher than a maximum temperature in the predetermined temperature range among the plurality of vehicles compared to the vehicle under an environment where the outside temperature is within the predetermined temperature range among the plurality of vehicles.

3. A vehicle comprising a power storage device, wherein the vehicle is configured to:
perform external charging for charging the power storage device by using electric power from an external power source and perform external power supply for supplying electric power from the power storage device to outside of the vehicle;
acquire a scheduled departure time; and
terminate the external charging or the external power supply at a time close to the scheduled departure time in a case where an outside temperature is lower than a minimum temperature in a predetermined temperature range compared to a case where the outside temperature is equal to or higher than the minimum temperature.
